(19) United States
(12) Patent Application Publication
(10) Pub. No.: US 2005/0188055 A1
(43) Pub. Date: Aug. 25, 2005

(54) Distributed and dynamic content replication for server cluster acceleration

(76) Inventor: Vikram A. Saletore, Olympia, WA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/750,167

(22) Filed: Dec. 31, 2003

(51) Int. Cl. G06F 15/16

(52) U.S. Cl. 709/218

(57) ABSTRACT

The present inventive subject matter relates to the field of network computing, and more specifically to methods, systems, and software for accelerated performance of server clusters, server farms, and server grids. Some such embodiments include methods, systems, and software, that when executing cause content into the memories of servers in a cluster, sharing the contents of the memories amongst all servers in the cluster over a high-speed interconnect to form a high-speed cluster-wide memory. Some such embodiments include servicing content requests from a server that may or may not have the requested content in its local memory, but is able to directly access the requested content in the memory of another server in the cluster over the high-speed cluster wide memory. One such embodiment includes caching the content obtained from the memory of the other server for use in servicing subsequent requests for that content.

### FIELD OF THE INVENTIVE SUBJECT MATTER

The present inventive subject matter relates to the field of network computing, and more specifically to methods, systems, and software for accelerated performance of server clusters.

### BACKGROUND

Computer networks are used for several purposes, one of which is providing access to content, stored on servers, that various network users or processes desire access to. With recent growth in network computing, network users and processes are putting great strain on the ability of network servers to satisfy all content requests. Current methods for meeting this growth in content demand simply add additional servers with replicated content on server hard disks. However, as the total volume of content grows, current servers are unable to scale to meet the increased storage requirements. Further, such current methods include increased periods of latency due to the slow access rates of hard disk storage. Accordingly, current methods and servers are not adequate to meet the continued content growth and demand.

### BRIEF DESCRIPTION OF THE DRAWINGS

FIG. 1 is a schematic diagram according to one example embodiment of the present inventive subject matter.

FIG. 2 is a block diagram according to one example embodiment of the present inventive subject matter.

FIG. 3 is a schematic diagram according to one example embodiment of the present inventive subject matter.

FIG. 4 is a schematic diagram according to one example embodiment of the present inventive subject matter.

FIG. 5 is a schematic diagram according to one example embodiment of the present inventive subject matter.

FIG. 6 is a schematic diagram according to one example embodiment of the present inventive subject matter.

FIG. 7 is a flow diagram according to one example embodiment of the present inventive subject matter.

FIG. 8 is a flow diagram according to one example embodiment of the present inventive subject matter.

FIG. 9 is a flow diagram according to one example embodiment of the present inventive subject matter.

FIG. 10 is a flow diagram according to one example embodiment of the present inventive subject matter.

FIG. 11 is a flow diagram according to one example embodiment of the present inventive subject matter.

### DETAILED DESCRIPTION

In the following detailed description of the preferred embodiments, reference is made to the accompanying drawings that form a part hereof, and in which are shown by way of illustration specific embodiments in which the inventive subject matter may be practiced. It is understood that other embodiments may be utilized and structural changes may be made without departing from the scope of the present inventive subject matter.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

### System

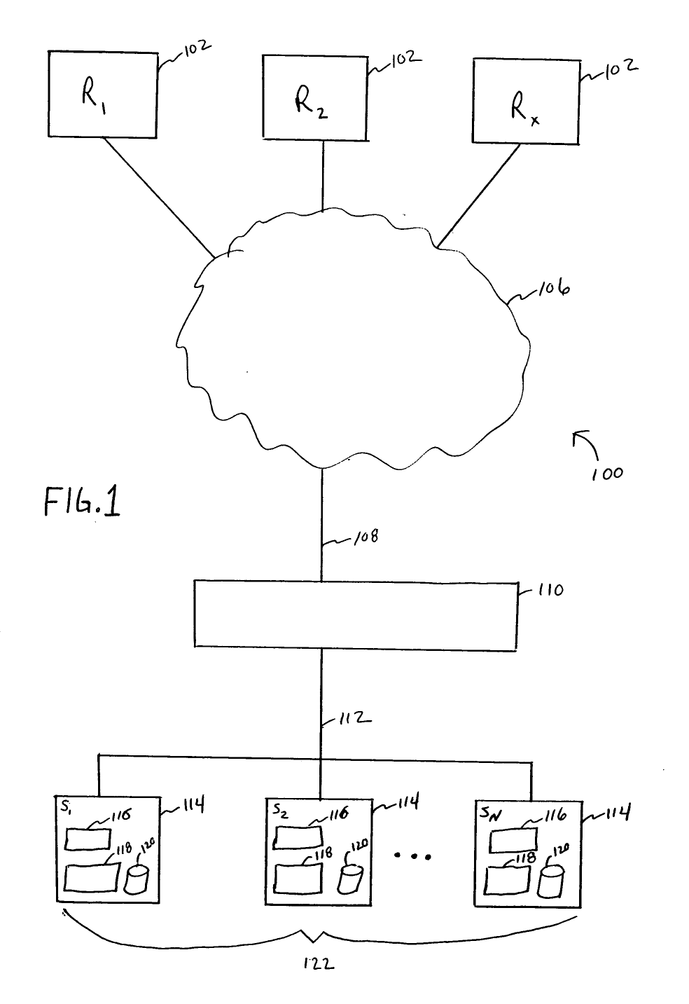

FIG. 1 is a schematic diagram of a system 100 according to one example embodiment of the present inventive subject matter. In some embodiments, system 100 includes a networking logic device 110, two or more servers 114 each operatively coupled 112 to the networking logic device 110. Each server 114 includes software 116 operable on the servers 114. This software 116 includes executable instructions to prime a memory 118 in each server 114 by distributing content from an electronic storage medium 120 to each server 114 memory 118 to provide each server 114 memory 118 with unique content. The software 116 in this embodiment further provides executable instructions to make the content of each server 114 local memory 118 available to the other remote servers 114 over the networking logic device 110 and further to receive and fulfill content requests with content from a server's 114 local memory 118 or from a memory 118 of another remote server 114.

In some embodiments, the software 116 is part of an operating system kernel that controls the operations of each of the servers 114. Other embodiments include the software 116 in a driver, or other middleware, that facilitates communication between the servers 114 over the networking logic device. Further embodiments include the software 116 in the user or application space of the servers 114.

Each of the above embodiments related to where and how the software 116 is implemented provide their own different benefits to meet particular needs. For example, in a new implementation or a replacement implementation, an embodiment with the software 116 in an operating system kernel provides the benefit of higher performance. In another example implementation such as an upgrade of an existing server cluster, upgrading the operating systems of servers in the cluster may not be possible or cost prohibitive. In such an implementation, the software 116 in a driver or in user space may be less cost prohibitive or the only means available for implementing the present inventive subject matter.

In various embodiments, the networking logic device 110 or system 100 performs one or more functions. These functions include the functions of a router, a network switch, a firewall, content director, and a load balancer for balancing a total content request load received from the network 106. In some embodiments, such requests are received from users of network clients 102 and from processes executing on network clients 102. In some embodiments, the function(s) of the networking logic device 110 are performed in a single physical device. Other embodiments include the functions of the networking logic device 110 in two or more physical devices.

In some embodiments, the present system 100 includes two or more servers 114 that form a server cluster 122 or a server farm 122 or a server grid 122. In some such embodiments, the server cluster 122 is a web cluster for servicing content requests received from clients 122 over the Internet. Other embodiments include receiving and servicing requests from an intranet and from other networks such as a local area network.

The configuration of the embodiment of system 100 shown in FIG. 1 allows for efficient fetching of content from servers 114 by exploiting an aggregated, large, and distributed server cluster 122 wide main memory Random Access Memory (RAM) 118 of commodity rack-mounted servers 114 interconnected over the networking logic device 110. Such an embodiment is generally relevant for use in a data center, and particularly relevant for use in an Internet data center.

System 100 improves the scalability of the server cluster 122 by distributing the content across the cluster 122 of servers 114 to provide each server 114 with unique content. System 100 also increases performance of the cluster 122 by minimizing access to high-latency hard disk. Minimizing access to high-latency hard disk is achieved by storing the unique content on each server 114 in the higher-speed (or low-latency) server 114 memory 118. Placing the unique content in the higher-speed memories 118 of the servers 114 allows for fetching of content on demand directly from the high-speed memories 118 of other servers 114 in the cluster 122 across the interconnection 112 of the servers 114 in the cluster 122.

In various embodiments, the interconnection 112, including the networking logic device 110, utilizes a high-speed networking technology such as industry standard Gigabit Ethernet technology enabled without or with TCP offload networking devices, or Infiniband technology, or Virtual Interface technology, or some other proprietary networking technology available from Myricom, Inc., or from Quadrics Inc. In some other embodiments, the high-speed networking technology is 10 Gigabit Ethernet. In some such embodiments, TCP offload engines are also utilized.

In some embodiments, the high-speed networking technology provides the ability for a server 114 to directly access the memory 118 and the storage 120 of another remote server 114 in the cluster 122. The direct memory access ability changes the memory hierarchy of the servers 114 from being introspective to being interspective. Each server has a local high-speed memory 118 augmented by high-speed access to the high-speed memories of the other servers 114 in the cluster 122 to form a large, virtual, high-speed memory of a size equal to the total memory space of all servers 114 in the cluster. Utilizing the high-speed networking technologies makes a high-speed cluster-wide memory a viable, scalable, and low latency storage for content. Thus, rather than having content of the server cluster 122 only accessible by the servers 114 from high-latency, low-speed hard disk (i.e., 120), the servers in an embodiment of the present inventive subject matter are able to quickly service requests by accessing content held in low-latency, high-speed memory 118.

As discussed above, the memory 118 of each server 114 in the cluster 122 is primed, or loaded, prior to being available to service requests, with unique content. The priming of the servers 114, in some embodiments, is performed by software 116 that executes on each server. In other embodiments, the server 114 memories 118 are primed over the interconnection 112 of the servers 114 under the control of software that executes within the networked environment. This software 116 also communicates with other servers 114 in the cluster 122 to make all servers 114 in the cluster 122 aware of the availability and memory location of the content in the high-speed cluster-wide memory. In some such embodiments, each server 114 maintains a table holding this content availability and location information. In some further embodiments where the networking logic device 110 performs a load balancing function, the networking logic device 110 routes, or directs, content requests to servers 114 based on availability and location information in the table.

In some embodiments, the networking logic device 110 is operatively coupled 108 to another network 106. In some such embodiments, the network 106 is a local area network, a wide area network, a wireless network, a global computing or communication network such as the Internet, or any other such network. The network 106 includes clients 102 that utilize the network 106 by requesting, receiving, and transmitting information across the network 106. In some embodiments, clients 102 request content located on one or more of the servers 114.

### Server Cluster: High-Speed Cluster-Wide Memory

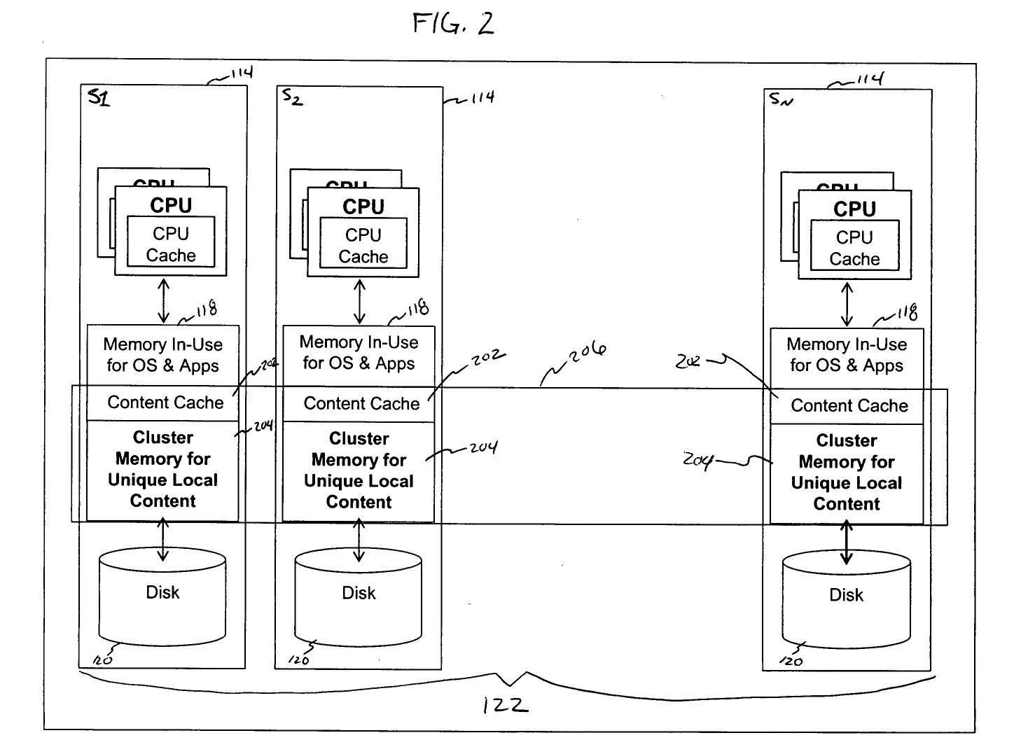

FIG. 2 is a block diagram of servers 114 and the high-speed cluster-wide memory 206 of the server 114 memories 118 (high-speed cluster-wide memory) according to one example embodiment of the present inventive subject matter. This embodiments provides a system including a network that operatively couples two or more servers 114 (i.e., S₁, S₂, . . . S_{N}, where N is the total number of servers) to allow high-speed memory access (as described above with reference to FIG. 1) between memories 118 of the two or more servers 114 in a server cluster 122 to form a high-speed cluster-wide memory 206. In this example embodiment, each server 114 has unique content stored in a portion 204 of memory 118 that is dedicated to the high-speed cluster-wide memory 206. Some such embodiments further include a content cache 202. In such embodiments including a content cache 202, content is stored in the content cache 202 from recent and common requests for unique content from another server 114. That content is fetched from the other servers 114 over the high-speed cluster interconnect 206 between the memories 118. The high-speed cluster interconnect makes the direct memory access that forms the high-speed cluster-wide memory possible. The high-speed cluster interconnect also allows for a first server 114 to directly access hard disk storage 120 on a remote server 114 without the content accessed on the remote server's hard disk 120 ever enter the remote server's 114 memory 118. The first server 114 can then place the content obtained from the hard disk 120 of the remote server 114 in the content cache 202 of the first server 114.

In some embodiments, the content cache 202 is located in a portion of the main memory 118 that is set aside to temporarily hold content of other servers 114 that has either been recently requested or is commonly requested from the high-speed cluster-wide memory 206. The content stored in the cache 202 portion of a server 114 memory 118 is maintained in accordance with common memory paging techniques that are readily apparent to those of skill in the relevant art. For example, the cached content stored in the memory 118 is maintained based on the size of the cache 202 portion of the memory 118 of a server 114 and the content stored in the cache 202. When more cache 202 space is needed in the memory, a determination of what content to purge from the cache 202 in the memory 118 is based on two factors: 1) the amount of space needed in the cache 202 to be freed up; and 2) hit ratios for the cache 202 content in the memory 118. The amount of space needed is determined and then taking into account the recency and commonality of requests for particular cached content are then balanced to determine what to purge.

In various embodiments, the unique content held in a memory 118 of a server 114, or held in the cache 202 portion of a server 114 memory 118, includes html documents, word processing documents, various types of graphics files and other multimedia types of content. In some other embodiments, one or more portions of a database are held in the memory 118, while other embodiments include other types of content and data. Virtually, any type of computer readable content can be held in the memory 118 of a server 114 as described herein.

The distribution of content across the memories 118 of the servers 114 in the cluster 122 as shown in FIG. 1 and FIG. 2, allows the size of the content to scale. For example, in an one embodiment of a sixteen server cluster 122, each server 114 being a 32-bit server dedicates 3 GB out of 4 GB of memory 118 per server 114 for storing primed content. In this embodiment, 1 GB of the total 4 GB memory space is reserved for a server 114 operating system and the balance, 3 GB, is dedicated to the server cluster 122 high-speed cluster-wide memory shared across the high-speed interconnect. This server cluster 122 of sixteen servers 114 can easily store 48 GB of content (3 GB×16 servers=48 GB). In another exemplary embodiment using 64-bit Itanium™ based servers, each with much larger main memory, dedicating 30 GB of server memory 118 out of a total 32 GB per server 114, results in a cluster of sixteen servers 114 with an aggregate high-speed distributed memory of 480 GB.

### EXAMPLES

Advantages and embodiments of the present inventive subject matter are further illustrated by the following two examples, but the particular elements recited in these examples, as well as other conditions and details, should not be construed to be limiting.

### System

### Example Embodiment I

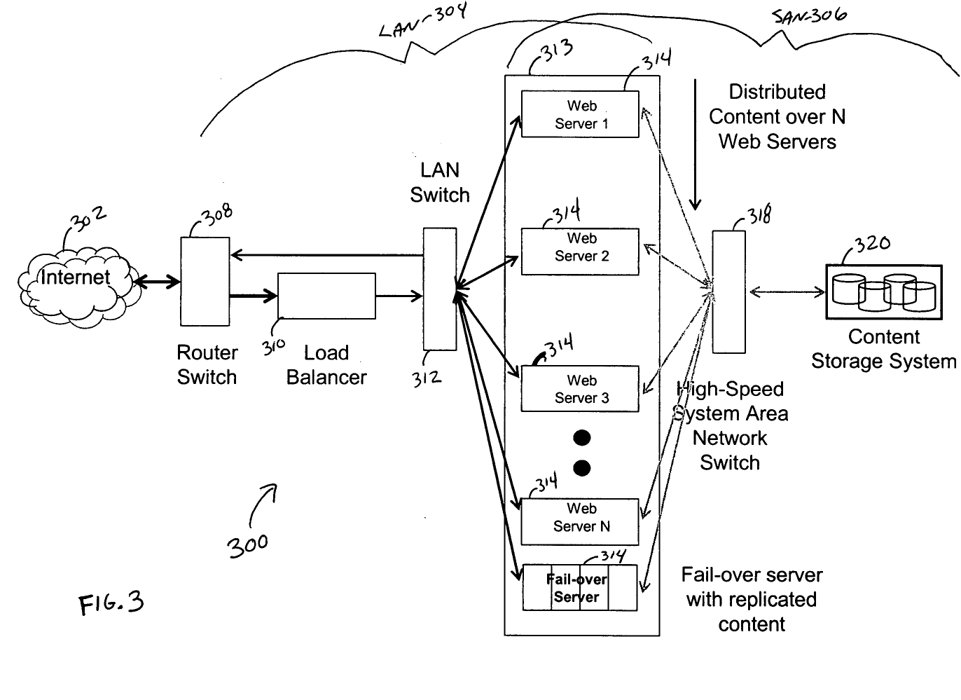

FIG. 3 is a schematic diagram of a system 300 in the Internet domain according to one example embodiment of the present inventive subject matter. This embodiment of system 300, as illustrated, includes three networks. These networks include a system area network 306, a LAN 304, and the Internet 302 or some other type of network on the outside of the router switch 308. Requests come into the system 300 from outside the router switch 308, are received and directed by the load balancer and content director 310, through a Local Area Network 304 (LAN) switch 312, to a web server 314 in a cluster 313. A web server 314 within the cluster 313 that receives a request and has already been primed with unique content from the backup content storage system 320, obtains the requested content from its local memory, cache, or from the high-speed cluster-wide memory, over the high-speed system area network 306. The system area network in this embodiment facilitates the high-speed cluster-wide memory access between the servers. The server 314 servicing the request then serves the requested content back through the LAN 304 to the router switch 308, bypassing the load balancer and content director 310, and to the Internet 302 or other outside network.

A system area network is generally a network that is used in a data center environment to interconnect various resources. Examples of system area networks include high-speed fiber optic networks between web servers, storage devices, and other network appliances or a gigabit Ethernet connection between networked assets in a data center. Some such embodiments of system area networks also include, industry standard Gigabit Ethernet technology enabled without or with TCP offload networking devices, or Infiniband technology, or Virtual Interface technology, or some other proprietary networking technology available from Myricom, Inc., or from Quadrics Inc. In some embodiments, system 300 for example, the servers 314 and the content storage system 320 are networked together within the system area network 306 utilizing a switch 318 enabled to perform at the higher-speed required by the system area network in, for example, an enterprise data center.

More specifically, system 300 includes a cluster 313 of web servers 314 used, for example, in a web farm. Requests from the clients 102 (shown in FIG. 1) on the Internet 302, are served by the web servers 314 in the cluster 313 by serving files that represent images, graphic objects, HTML pages, or other web content, from a specific server 314 to construct web pages that are served to the requesting clients 102. For fail-over, or backup, purposes, the web content typically resides on external storage 320. However, the most frequently or recently accessed web content, or “hot” content, resides in the high-speed cluster-wide memory distributed amongst the web servers 314. The most frequently or recently accessed content is available to all of the servers via the high-speed cluster-wide memory described above, while the content not in memory is available to the web servers 314 on the external storage. Thus, in this exemplary embodiment, the universe of content available in system 300 is larger than the aggregate amount of high-speed cluster-wide memory, while in other embodiments of the present inventive subject matter, the universe of content available in a system is of a size that is equal to or less than the amount of memory allocated to the high-speed cluster-wide memory.

In some embodiments, the external storage 320 is a Storage Area Network (SAN). In various other embodiments, the external storage 320 is a relational database management system (RDBMS), one or more file servers, a disk array, or any other non-volatile computer readable medium storage device or system.

In the embodiment of system 300, the content is statically partitioned, distributed, and primed across the high-speed cluster-wide memory 318 of the web servers 314 on the cluster interconnect facilitated by the system area network 306. The partitioning of the content ranges, in various embodiments, from a simple directory and file based content distribution to an intelligent distribution based on client access rates to specific content objects and the content working set requirements of individual servers. Each server owns unique content and has the knowledge of where all other content resides, functioning as an intelligent content director. In addition, each server also functions as an intelligent load balancer in its own right by having the ability to service requests for content located on other servers. The content in some embodiments, as in system 300, is duplicated as well to provide fail-over in the event that a server goes down or for any other failure in a web server 314 in the cluster 313.

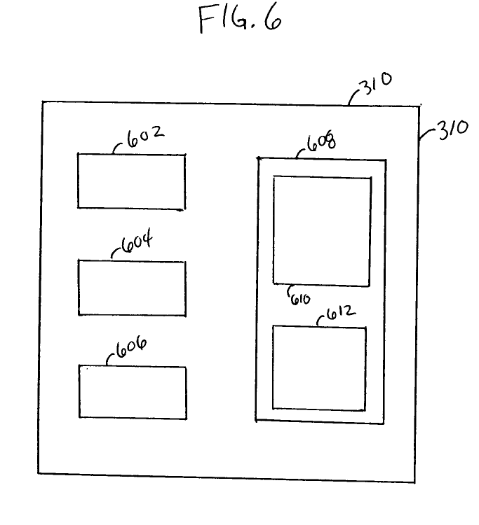

The embodiment of system 300 includes routing inbound content requests using a load balancer 310. In various embodiments, the load balancer 310 routes requests in a round robin fashion amongst all of the servers 314. In other embodiments, the load balancer takes into account the current load of the servers 314 in the cluster 313 and the location of content on a server 314. Such load balancers are discussed in greater detail below with regard to FIG. 6.

If a server 314 in the cluster 313 receives a request for content the server 314 owns, the server 314 serves the content out of its main memory that was primed prior to receiving the request. If the server 314 receives a request for content that it does not own, the server 314 dynamically fetches the necessary content from a specific remote server's 314 memory over the high-speed cluster-wide memory to its own memory first and then services the request with content out of its memory with this dynamically replicated content. In some embodiments, the dynamically replicated content then continues to reside in the server's content cache portion of memory according to common memory paging techniques described above.

Embodiments utilizing this dynamic replication of content allows the number of requests served to scale because it allows a server 314 to serve content that it owns from its own high-speed (i.e., less than 100 of nanoseconds of memory latency) main memory. The server 314 also is able to serve content that it does not own by fetching content from a remote server 314 in the cluster 313 with low latency over the high-speed cluster-wide memory. Thus, in these embodiments, the need to access high-latency hard disk storage is either eliminated or reduced considerably, thus significantly increasing performance of each server 314 in the cluster 313 and the cluster 313 as a whole.

This dynamic replication of content is also beneficial during spurts of high request rates for certain content, such as during periods of bad weather, tragedy, or breaking news. The dynamic replication provides servers 314 the ability to quickly service requests for content even if the servers are not the owners of the content. This removes pressure from the server owning the content and from all three networks shown in FIG. 3 by reducing latency in servicing content requests that hold network connections open. Thus, not only are requests serviced more quickly because the content is more readily available through the dynamic content replication, but requests are also not subjected to long periods in a queue due to the latency of content requests ahead in the queue.

In some embodiments, system 300 also includes a failover server 316. In one such embodiment, Failover server 316 is provided to fill in for one or more servers 314 in the cluster 313 should one or more servers 313 fail. In one such embodiment, failover server 316 replicates the universe of content in the cluster 313 and can fill in for up to and including all servers in the cluster. In such an instance that failover server 316 takes over for the entirety of the servers 314 in the cluster 313, performance of the cluster would be significantly lower for serving content as the fail-over server 316 memory will not have been primed and the content will need to be fetched from the storage system 320. However, the failover server 316 would ensure that the content would still be available, albeit with higher latency.

### System

### Example Embodiment II

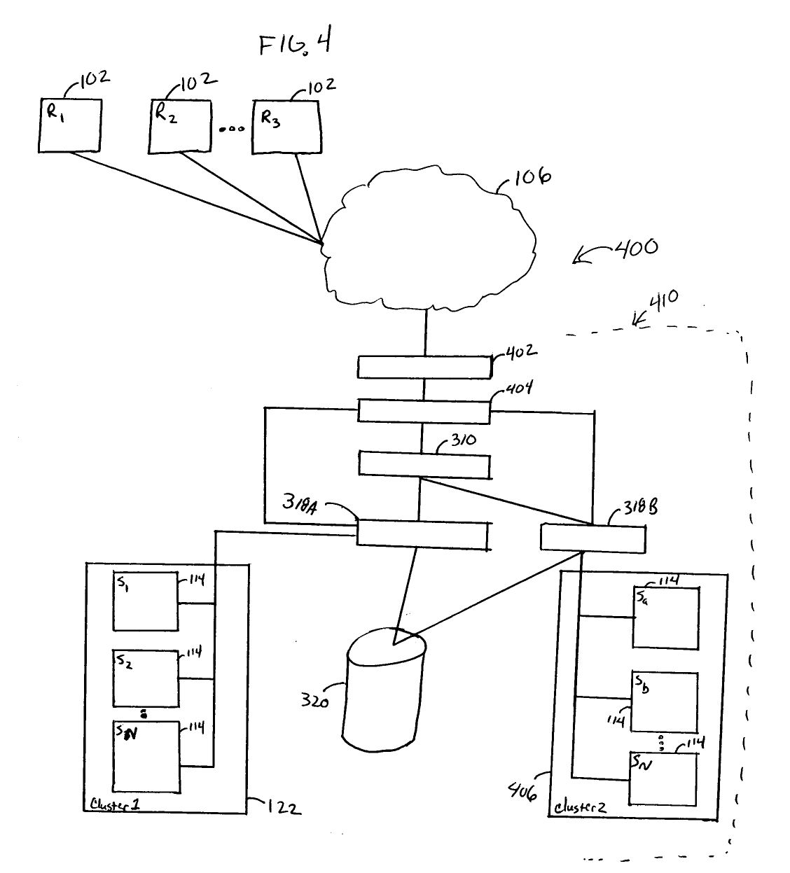

FIG. 4 shows a schematic diagram of a system 400 according to one example embodiment of the present inventive subject matter. System 400 includes requesters 102 that are connected to and request content over the Internet 106 from an entity 410. Entity 410 includes a connection to the Internet 106 from which it receives requests.

In some embodiments, entity 410 is a networked environment including a firewall 402 connected to the Internet and a router 404 coupled to the firewall. Connected to the router 404 in this embodiment is a load balancer 310 and two system area network switches 318A and 318B. The load balancer 310 is also connected to both system area network switches 318A and 318B. The first system area network switch 318A is also connected to a content storage system 320 and a main server cluster 122. The second system area network switch 318B is also connected to the content storage system 320 and a failover server cluster 406.

System 400 operates similarly to system 300 except that rather than having a single failover server 316 (as shown in FIG. 3), system 400 has a failover cluster that can take over in the event that the main server cluster 122 fails in part or in whole. System 400 is also able to handle failures in the first or second system area network switches 318A and 318B. Thus, system 400 is well suited for systems that cannot sustain degradation in performance in the event of partial or entire system failure.

### Server

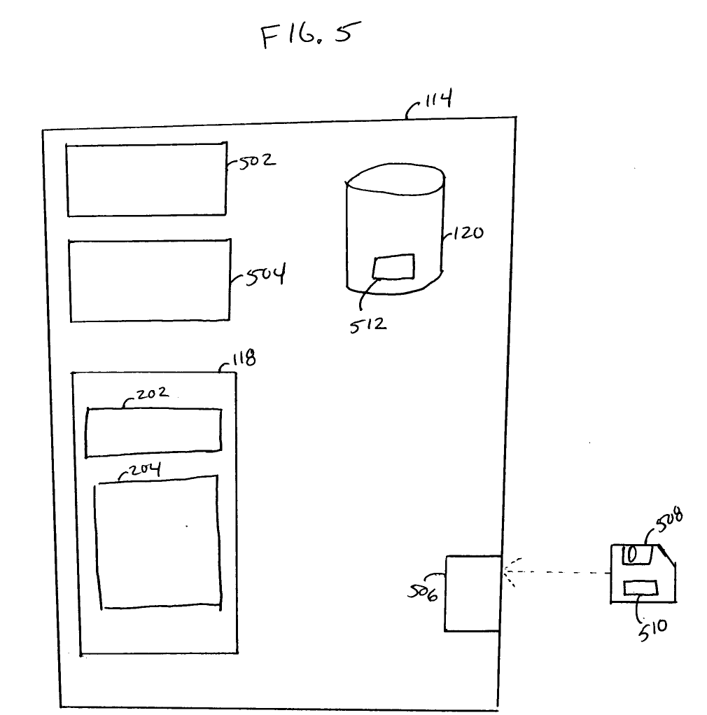

FIG. 5 is a schematic diagram of a server 114 according to one example embodiment of the present inventive subject matter. A server 114 includes one or more processors 502, a memory 118, a storage device 120, and one or more network interfaces 504. In this embodiment, server 114 further includes software 512 operable on the processor 502 to load unique content into the memory 118, receive content requests over the network interface 504, and service received requests for content in the memory 118. The software further allows the server 114 to service requests for content located in a memory 118 of another remote server 114 by obtaining the content over the network interface 504. Some further embodiments provide the server 114 with the ability to cache content, in a portion of the memory 118, the content obtained in servicing request for content located on other servers 114. Such cached content is then used for servicing subsequent requests for identical content as described above.

The processor 502 in a server 114 is generally one or more central processing units (CPUs). An example of such a processor or processors is a Pentium class processor such as a 3 GHz processor available from Intel Corporation. However, the processor 502 can be any processor in a server including a RISC processor, or any other such CPU.

The memory 118 in a server 114 is generally a high-speed memory capable of storing content. In some such embodiments, memory 118 includes RAM (Random Access Memory). Other embodiments include various other memory types, while some other embodiments include various combinations of memory types including RAM and flash memory.

The one or more network interfaces 504 connect the server 114 to various networks. Some such networks include Local Area Networks (LAN), Wide Area Networks (WAN), wireless networks, and system area networks. These network, or other similar network, in some embodiments, are connected to and provide access to yet further networks such as the Internet. The one or more network interfaces 504 include the hardware and software required for connecting to these networks. Such hardware includes Network Interface Cards (NIC) for wired and wireless connections or could also be integrated into a board in a computer such as a PC motherboard, chip set, or even in the CPU itself. Such software includes drivers and application programming interfaces necessary to communicate with such hardware over such networks.

In some embodiments of a server 114, the server 114 further includes a media reader 506. In some such embodiments, the media reader 506 is capable of receiving and reading a computer readable medium 508. In some such embodiments, the computer readable medium 508 has computer executable instructions 510 that cause a suitably configured computer to perform the methods of the present inventive subject matter. In some other embodiments, data is stored on and loaded to memory 118 from the computer readable medium 508. In various embodiments, the computer readable medium 508 is a Compact Disk (CD), a Digital Versatile Disk (DVD), a floppy disk, a removable hard drive, and other similar computer readable medium 508. In other embodiments, the computer readable medium 508 is a carrier wave with signals encoded therein that contain the computer executable instructions 510 that cause a suitably configured computer to perform the methods of the present inventive subject matter.

### Load Balancer

FIG. 6 is a schematic diagram of a load balancer according to one example embodiment of the present inventive subject matter. In some embodiments, the load balancer 310 includes a network interface for inbound signals 602 and outbound signals 604. However, in some other embodiments, inbound signals and outbound signals utilize a single network interface. The load balancer 310 further includes a processor 606 and a memory 608. In some such embodiments, the memory 608 includes software 612 for load balancing requests across a network. In one such embodiment, the software 612 includes instructions that are executable on the processor 606 to cause content requests that are received over the inbound network interface 602 to be routed in a round robin fashion servers in a server cluster. This round robin fashion includes routing a first request to a first server, a second request to a second server, and so on until all servers in the cluster have been allocated a request. Then the software 612 returns to the first server and starts over. In another embodiment, the software 612 includes instructions that routes content requests to servers based on the content located on a server and a current load on the server having the content. Such embodiments can be classified as making the load balancer 310 an intelligent load balancer 310 or a content director 310. In such an embodiment, the load balancer has a table 610 or other data structure located in memory 608 that provided information to the software 612 that is necessary in determining the location of content and current load on a server. Other embodiments of the software 612 on the load balancer 310 only take into account the location of the requested content.

### System Methods

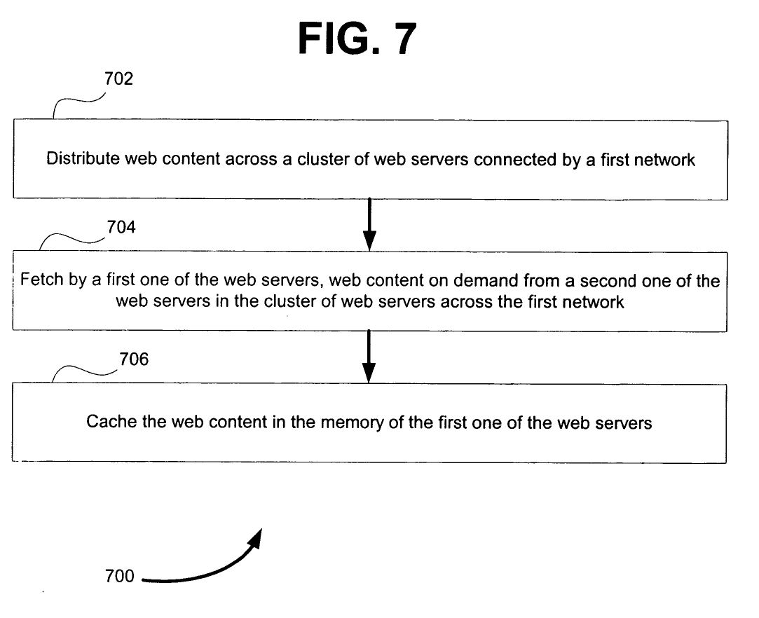

FIG. 7 is a flow diagram of a method 700 according to an embodiment of the present inventive subject matter. In some embodiments, method 700 includes distributing 702 web content across a cluster of web servers connected by a first network and fetching 704, by a first one of the web servers, web content on demand from a second one of the web servers in the cluster of web servers across the first network. Additional embodiments of system 700 include the first server responding to requests from the web with content from the memory of the first server. Other embodiments include the first server responding to requests from the web with content from the memory of the second server. Some further embodiments also include caching 706 the web content in the memory of the first one of the web servers.

In one such embodiment where the web content is stored in the memory of the first one of the web servers, the memory of the web servers is divided into two portions. The first portion is reserved for general server use, such as by the server operating system and other processes and programs executing or residing on the server. The second portion is reserved for caching web content.

In some further embodiments, the second portion of the server memory reserved for caching of web content is divided once more into two portions. One portion is reserved for caching content that is distributed to the specific server. The other portion is reserved for caching content that has been fetched from other servers in the server cluster.

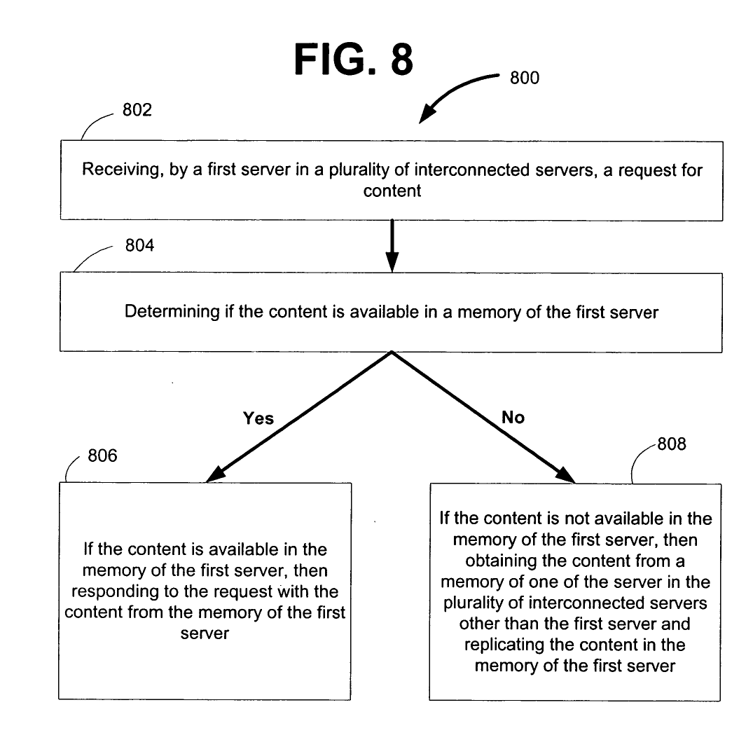

FIG. 8 is a flow diagram of a method 800 according to one example embodiment of the present inventive subject matter. In some embodiments, method 800 is encoded as computer executable instructions on a computer readable medium. In some embodiments, method 800 includes receiving 802, by a first server in a plurality of interconnected servers, a request for content and determining 804 if the content is available in a memory of the first server. In some such embodiments, if the content is available in the memory of the first server, the method 800 includes responding 806 to the request with the content from the memory of the first server. Further in this embodiment, if the content is not available in the memory of the first server, the method 800 includes obtaining 808 the content from a memory of one of the servers in the plurality of interconnected servers other than the first server and replicating the content in the memory of the first server. In some such embodiments, the requests are responded 806 to with content from the memory of the first server.

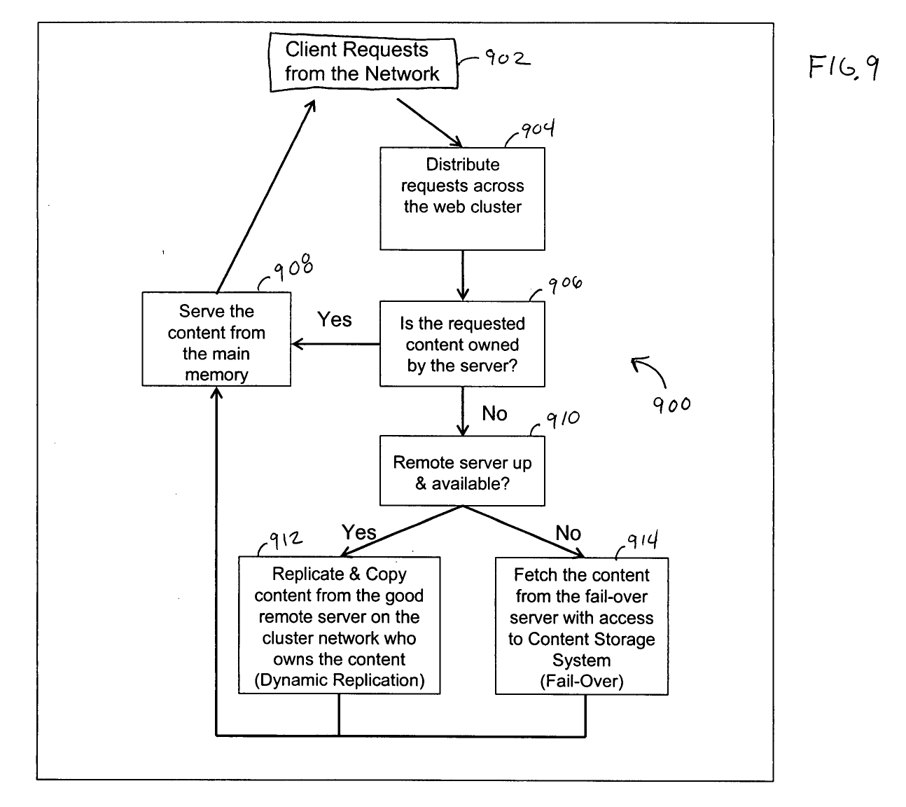

FIG. 9 is a flow diagram of a method 900 according one example embodiment of the present inventive subject matter. The method 900 includes receiving 902 requests into a system, distributing 904 the requests across a server cluster, server farm, or server grid. The requests, in various embodiments as described above, are distributed according to one more methods including a round-robin method, a method that takes into account the location of the content requested in request, and the content requested and the current load a of server owning or having a dynamic copy of the requested content cache in the server memory. Other methods of load balancing will be readily apparent to those of skill in the relevant art and are contemplated in the present inventive subject matter.

After a request is distributed 904, a server receiving the request determines 906 if the requested content is owned by the server. If the content is owned by the server, the content is copied from memory and served 908 back to the requester. However, if the content is not owned by the server receiving the request, the server determines 906 which remote server in the cluster has the content loaded in memory and determines 910 if that server is available. If the content is available in the memory of that server and the server is available, the server copies 912 the content from the remote server's memory and replicates that content in the server's content cache in memory, if it has such a content cache. The server then serves 908 the content to the requestor.

If the server is unable to obtain the content from the remote server's memory, the server then fetches 914 the content from a failover server such as failover server 316 shown in FIG. 3. Or if the server cluster does not have failover server 316, the content is obtained from a failover cluster such as failover server cluster 406 shown in FIG. 4. If there is not a failover server 316 or a failover cluster 406, the content is then retrieved from a content storage system 320 shown in FIG. 3. Then, once the requested content is obtained, it is cached if the server has a content cache space in the server's main memory, and served 908 to the requestor.

### Server Methods

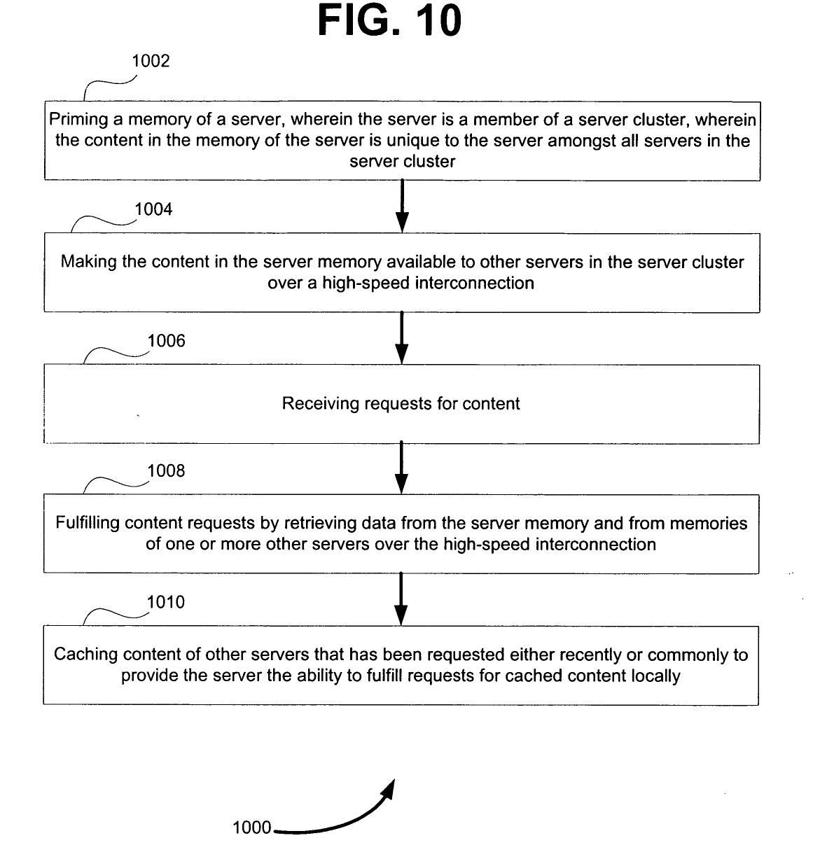

FIG. 10 is a flow diagram of a method 1000 according to one example embodiment of the present inventive subject matter. In some embodiments, method 1000 includes priming 1002 a memory of a server that is a member of a server cluster and the content in the memory of the server is unique to the server amongst all servers in the server cluster. This embodiment of the method 1000 further includes making 1004 the content in the server memory available to other servers in the server cluster over a high-speed interconnection, receiving 1006 requests for content, and fulfilling 1008 those requests by retrieving data from the server memory and from memories of one or more other servers over the high-speed interconnection. Some such embodiments further include caching 1010 content of other servers that has been requested either recently or commonly to provide the server the ability to fulfill requests for cached content locally. In some embodiments, the caching 1010 is performed in accordance with common memory paging techniques that are readily apparent to those of skill in the relevant art as discussed more fully above.

### Example Embodiment III

Advantages and embodiments of the present inventive subject matter are further illustrated by the following example, but the particular elements recited in this example, as well as other conditions and details, should not be construed to be limiting.

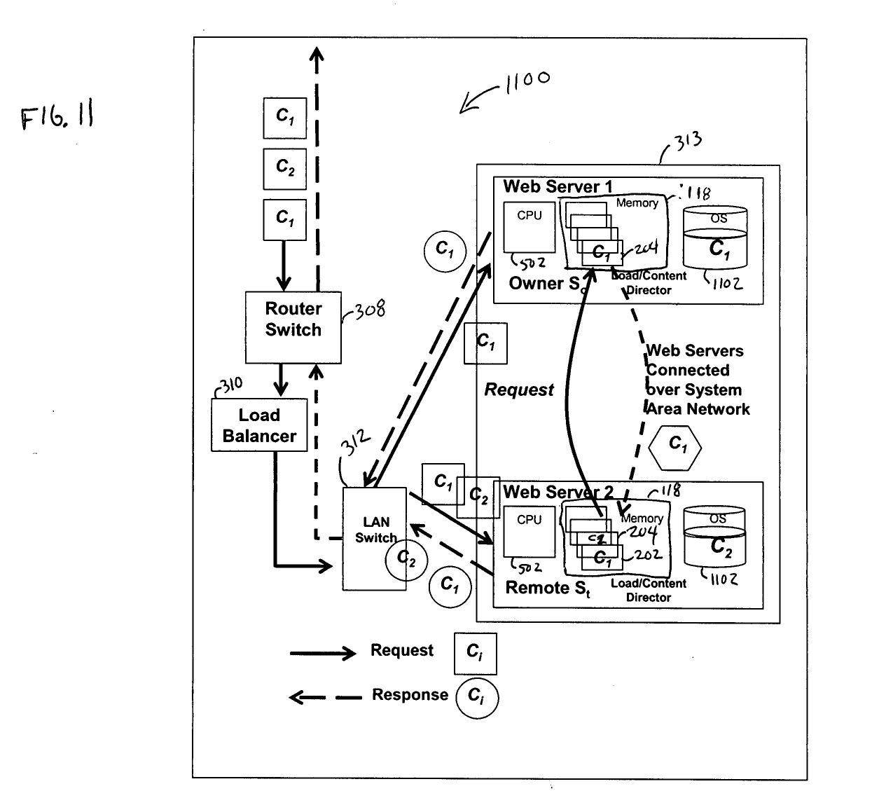

FIG. 11 is a flow diagram of the operation of a system 1100 according to one example embodiment of the present inventive subject matter. This flow diagram includes a web cluster 313 of two web servers 314, Web Server 1 and Web Server 2. Content C₁ is stored on Web Server 1 which is also the “primary owner” of content C₁. Content C₂ is stored on Web Server 2 and which is the primary owner of content C₂. Each web server 314 in the cluster 314 has a memory 118 having a content cache 202 portion and a portion dedicated to a high-speed cluster-wide memory 204 which is shared over a high-speed interconnect facilitated by a system area network (not shown in FIG. 11).

Incoming client requests from the Internet are received from the Internet by a router 308, request balanced by a load balancer 310, and sent to a web server 314 over a LAN switch 312. The responses to those requests with content are sent directly by the web servers 314 to the requestors through the LAN Switch 312, to the router 308, and over the Internet 302, bypassing the load balancer 310.

FIG. 11 illustrates three content requests for content C₁, C₂, and C₁ received over the Internet 302. The load balancer 310, in this example, routes the first request (for content C₁) to Web Server 1 and the third request (for content C₂ and C₁) to Web Server 2. Web Server 1, the primary owner of content C₁ has been primed its cluster wide memory 204 portion of memory 118 with content C₁. Web Server 2, the primary owner of content C₂ has been primed its cluster wide memory 204 portion of memory 118 with content C₂.

Web Server 1 receives the request for content C₁. Web Server 1 determines that the content C₁ is already primed in the high-speed, cluster-wide memory 204 portion of memory 118 and services the request directly to the requester. However, due to a high volume of recent requests for content C₁, Web Server 1 determines that the content C₁ should now reside the in the high-speed, cluster-wide memory 204 and serves the requests directly.

Web Server 2 responds directly to the requestor for content C₂ after determining the requested content C₂ is already primed into the high-speed, cluster-wide memory 204 portion of memory 118 on Web Server 2. Web Server 2 receives the request for content C₁, determines that the content is not available on Web Server 2. Web Server 2 then replicates content C₁ in the content cache 202 portion of the memory 118 from the high-speed, cluster-wide memory 118 over the high-speed interconnect, and responds to the request for content C₁ directly to the requester through the LAN switch 312 and router 308, bypassing the load balancer 310.

Thus, as illustrated in FIG. 11, when a client request for content Cᵢ is received by a web server 314 for content that it does not own, the web server 314 determines which server owns that content, replicates the content Cᵢ from the web server 314 in the cluster 313 that owns the content over the high-speed interconnect facilitated by the system area network to its content cache portion 202 of memory 118, and serves the content directly to the client.

This dynamic content retrieval can take place in a number of ways. First, if a request is for content is already residing in the memory of the remote server, then the content Cᵢ is retrieved directly from the remote server and replicated at least temporarily in a content cache 202 of memory 118 on the local server using a memory to memory transfer within the high-speed cluster-wide memory over the high-speed cluster interconnect. Second, if the request is for content residing on a local hard disk 1102 of the remote server 314, then the content is retrieved directly from the file system of the remote server across the high-speed cluster interconnect and replicated at least temporarily in a content cache 202 of memory 118 on the local server.

It is understood that the above description is intended to be illustrative, and not restrictive. Many other embodiments will be apparent to those of skill in the art upon reviewing the above description. The scope of the inventive subject matter should, therefore, be determined with reference to the appended claims, along with the full scope of equivalents to which such claims are entitled.

1. A server comprising:
a processor;
a memory;
a system area network connection;
a local area network connection; and
software operable on the processor to:
load unique content into the memory from a storage location,
receive requests for content over the local area network,
service requests for the content in memory,
service requests for content located in a memory of another server by obtaining the content over the system area network, and
cache content used to service request for content located in the memory of the other server for use in servicing subsequent requests for identical content.

2. The server of claim 1, wherein the software operable on the processor is a component of an operating system of the server.

3. The server of claim 1, wherein the software operable on the processor is a driver.

4. The server of claim 1, wherein the software operable on the processor is a middleware component.

5. The server of claim 1, wherein the system area network is a Gigabit Ethernet network.

6. The server of claim 5, wherein the Gigabit Ethernet network is TCP Offload Engine enabled.

7. The server of claim 1, wherein the unique content is loaded into memory prior to the server being available to service content requests.

8. A system comprising:
a networking logic device;
two or more servers, each server operatively coupled to the networking logic device; and
an operating system on each of the two or more servers including one or more software components including executable instructions to:
make the content of each server memory available to the other servers over the networking logic device, and
receive and fulfill content requests over the networking logic device with content from a server's local memory or from a memory of another server over the networking logic device.

9. The system of claim 8, wherein the networking logic device performs one or more of the functions of devices including:
a router;
a switch;
a firewall;
a load balancer; or
a content director.

10. The system of claim 8, the system further comprising:
an electronic storage medium system operatively coupled to the networking logic device, wherein content is stored in the electronic storage medium system.

11. The system of claim 10, wherein the electronic storage medium system is a storage area network.

12. The system of claim 8, wherein the software further includes executable instructions to cache content of other servers in memory for use in fulfilling later requests for the content in the cache.

13. The system of claim 8, wherein the software further includes executable instructions to:
maintain a table of content available on the system area network and the location of the content, and
obtain content from another server based on the table of content available on the system area network.

14. The system of claim 13, wherein the networking logic device maintains a table of content available on the system area network and routes requests based on the table.

15. A method of server operation comprising:
priming a memory of a server, wherein the server is a member of a server cluster, wherein the content in the memory of the server is unique to the server amongst all servers in the server cluster;
making the content in the server memory available to other servers in the server cluster over a high-speed interconnection;
receiving requests for content;
fulfilling content requests by retrieving data from the server memory and from memories of one or more other servers over the high-speed interconnection; and
caching content of other servers that has been requested either recently or commonly to provide the server the ability to fulfill requests for cached content locally.

16. The method of claim 15, wherein requests for content are received over a local area network connection.

17. The method of claim 16, wherein requests are received into the local area network on a router coupled to the Internet.

18. A method comprising:
distributing web content across a cluster of web servers connected by a first network;
fetching, by a first one of the web servers, web content on demand from a second one of the web servers in the cluster of web servers across the first network; and
caching the web content in the memory of the first one of the web servers.

19. The method of claim 18 wherein the web content is fetched from the memory of the second one of the web servers.

20. The method of claim 18 further comprising responding to the request with the web content from the memory of the first server.

21. An article comprising a computer-readable medium containing associated information, wherein the information, when accessed, results in a machine performing:
receiving, by a first server in a plurality of interconnected servers, a request for content; and
determining if the content is available in a memory of the first server:
if the content is available in the memory of the first server, then responding to the request with the content from the memory of the first server;
if the content is not available in the memory of the first server, then obtaining the content from a memory of one of the servers in the plurality of interconnected servers other than the first server and replicating the content in the memory of the first server.

22. The article of claim 21 further comprising responding to the request with the content from the memory of the first server.

23. The article of claim 22 further comprising responding to a subsequent request for the content with the content from the memory of the first server.
